(19) United States
(12) Patent Application Publication
(10) Pub. No.: US 2025/0167318 A1
(43) Pub. Date: May 22, 2025

(54) TESTING DEVICE AND METHOD FOR TESTING SEGMENTS FOR THE ENERGY CELL MANUFACTURING INDUSTRY

(71) Applicant: KÖRBER TECHNOLOGIES GMBH, HAMBURG (DE)

(72) Inventors: Nils KLAPER, DRAGE (DE); Jan KREYSERN, HAMBURG (DE); Karsten MEINKE, MÖLLN (DE); Johannes MÜLLER, HAMBURG (DE); Christian Frédéric ADOLFF, HAMBURG (DE)

(21) Appl. No.: 18/840,206

(22) PCT Filed: Feb. 13, 2023
(86) PCT No.: PCT/EP2023/053490

§ 371 Date: Aug. 21, 2024

(30) Foreign Application Priority Data
Feb. 24, 2022 (DE) 10 2022 104 468.8

(51) Int. Cl. H01M 10/42

(52) U.S. Cl. CPC H01M 10/4285

(57) ABSTRACT

A testing device for testing segments that are suitable for forming a cell stack for the energy cell producing industry, wherein a conveying apparatus having a plurality of receiving portions is provided for receiving and transporting one segment in each case, wherein the receiving portions can be moved relative to a stationary part of the testing device by a movement of the conveying apparatus, wherein the receiving portions each comprise at least two contact surfaces for electrical and/or signalling contact of a segment received in the corresponding receiving portion.

The present invention relates to a testing device having the features of the preamble of claim 1 and to a corresponding method having the features of the preamble of claim 12.

Energy cells or energy storage cells such as battery cells are used for galvanic accumulators, for example in motor vehicles, other land vehicles, ships and airplanes, where a considerable amount of energy must be retrievably stored for long periods of time. For this purpose, such energy cells have a structure consisting of a plurality of segments stacked to form a stack, hereinafter referred to as a cell stack. These segments are formed by monocells, for example. Monocells are alternating anode sheets and cathode sheets, also known as electrodes, which are separated from each other by separator sheets. A monocell therefore typically has the following layer sequence: separator-anode-separator-cathode.

The segments are pre-cut in the production process and then placed on top of each other in the predetermined sequence to form the cell stacks and joined together by lamination.

Devices for producing battery cells are known, for example, from WO 2016/041713 A1 and DE 10 2017 216 213 A1.

The segments may be damaged during the production process. In the case of segments in the form of monocells, it is possible, for example, that the separator is damaged during production. If a monocell with a damaged separator is used to form the cell stack, this can negatively affect the functionality and service life.

Energy cells can also be fuel cells or solar cells, for example, where segments can also be damaged during production.

It is therefore known in principle from the prior art to test segments before the stacking process and, if necessary, to eject them from the production process so that only flawless segments are used to form a cell stack.

Such test procedures must take into account the production output and conveying speed of current production systems. It is therefore known in principle from the prior art to provide testing apparatuses that move along with the segments in the production process and alternately test the segments. For this purpose, the testing apparatus actively contacts what are known as conductor lugs, which are part of the electrodes. However, the performance of the machine is limited in such test procedures due to the discontinuous movements. Furthermore, the segments can be damaged when contacting the conductor lugs.

The object of the present application is to provide an improved testing device for testing segments, and a corresponding method.

The object is achieved by the features of the independent claims. Further preferred embodiments of the invention can be found in the dependent claims, the figures, and the associated description.

Accordingly, to achieve the object, a testing device for testing segments that are suitable for forming a cell stack for the energy cell producing industry is proposed, wherein a conveying apparatus having a plurality of receiving portions is provided for receiving and transporting one segment in each case, wherein the receiving portions can be moved relative to a stationary part of the testing device by a movement of the conveying apparatus, wherein the receiving portions each comprise at least two contact surfaces for electrical and/or signalling contact of a segment received in the corresponding receiving portion.

The segments positioned in the receiving portions can be transported by means of the conveying apparatus, wherein the segments can be tested during the transportation process by means of the contact surfaces. For example, conclusions can be drawn about the system state of the respective segment on the basis of a measurement of the ohmic resistance between the at least two, preferably exactly two, contact surfaces. If, for example, the segment is formed by a monocell as described above, then the ohmic resistance between two electrodes can be reduced if the separator arranged between these electrodes is damaged.

Furthermore, the contact surfaces, as part of the receiving portions, offer the advantage that extremely gentle electrical contacting of the segment is made possible. If, for example, a segment in the form of a monocell is used, then a separator of the segment to be tested rests on a rest surface of the respective receiving portion, followed by an electrode, for example an anode, another separator and another electrode, for example a cathode. To allow the electrodes to be electrically contacted, the electrodes usually have the conductor lugs mentioned above, which protrude beyond the base area of the separators. The conductor lugs also have a very thin layer thickness and are therefore extremely sensitive. By means of the contact surfaces, which are preferably oriented parallel to the rest surface of the receiving portions, the conductor lugs can be contacted particularly gently. In order to improve the contacting between the conductor lugs and the contact surfaces, the contact surfaces can also protrude from the plane of the rest surface so that the contact surfaces press against the conductor lugs.

Preferably, the conveying apparatus is formed by a drum which is mounted for rotation around an axle element and on the radially outer lateral surface of which the receiving portions are arranged. This means that the segments to be tested can be conveyed by a rotational movement, which is particularly simple and efficient. Alternatively, the conveying apparatus can also be formed by a linear conveying system, for example by a belt system. In this case, for example the surface of the belt has receiving portions having the respective contact surfaces.

According to another preferred embodiment, it is proposed that the receiving portions each comprise a rest surface for supporting a segment, the rest surface being electrically insulated from the contact surfaces. This means that the cell stack can be reliably mounted by the rest surface, while the conductor lugs lie on the contact surfaces for the purpose of electrical and/or signalling contact. In this way, it can be ensured that the measurement of electrical parameters which is carried out via the contact surfaces is not negatively affected. Preferably, this can be implemented by the rest surface being made of an electrically non-conductive material and by the contact surfaces being electrically conductive.

Preferably, the contact surfaces of the receiving portions can be connected to at least one measuring apparatus with respect to signalling and/or electrically. It is also preferable that the contact surfaces of each receiving portion can be selectively connected to the at least one measuring apparatus. In this way, a separate measuring apparatus does not have to be provided for each receiving portion, but rather the contact surfaces of the receiving portions can be connected separately to the at least one measuring apparatus.

Preferably, the signalling and/or electrical connection of one or more contact surfaces of a specific receiving portion to the at least one measuring apparatus can be established and/or interrupted according to the position of the conveying apparatus relative to the stationary part. Furthermore, for example a plurality of measuring apparatuses can also be provided for measuring different parameters, which measuring apparatuses can be connected to the contact surfaces of a receiving portion one after the other or in parallel. Thus, by connecting the contact surfaces to different measuring apparatuses one after the other, different measurements can be carried out without the need to remove the segment from the contact surfaces of a receiving portion.

Preferably, the at least one measuring apparatus is part of the stationary part. Accordingly, the measuring apparatus does not have to be moved with the conveying apparatus.

Preferably, the signalling and/or electrical connection of one or more of the contact surfaces of a respective one of the receiving portions to the at least one measuring apparatus can be established by means of at least one sliding contact apparatus. The sliding contact apparatus can comprise, for example, contact skids and contact brushes which can be contacted with one another. For this purpose, the contact skids can be arranged, for example, on the radially outer lateral surface of the axle element and the contact skids can be connected to the contact brushes on the radially inner surface of the drum. The contact skids preferably do not extend over the entire circumference of the axle element, but rather only over a portion of the circumference, so that, in a controlled way, the contacting of the contact surfaces of a receiving portion is possible for the period of time in which the respective contact brushes contact the contact skids. In principle, an inverted arrangement of the contact skids and the contact brushes is also possible, wherein the contact brushes are arranged on the radially outer lateral surface of the axle element and the contact skids are arranged on the radially inner surface of the drum.

In principle, the signalling and/or electrical connection of one or more of the contact surfaces of a receiving portion to the at least one measuring apparatus can also be accomplished by means of contactless transmission systems.

According to another preferred embodiment, it is proposed that a plurality of measuring apparatuses is provided, and the signalling and/or electrical connection of the contact surfaces of two or more receiving portions, each to a different measuring apparatus, can be established with temporal overlap. Only a limited portion of the movement apparatus is available for the measuring process. As a result of the temporal overlap when connecting, for example, adjacent receiving portions to different measuring apparatuses, the measuring process can be at least partially parallelised. This means that overall a longer measurement interval is available for the measurements with each of the measuring apparatuses, which enables measurement results of higher quality to be generated. The design of the parallel connection provides a parameter with which the available measuring duration can be adjusted independently of the production speed.

Preferably, the receiving portions each comprise a first and a second contact surface which are arranged in the respective receiving portion such that they are electrically insulated from one another. It is also preferable that the first and second contact surfaces are arranged in the respective receiving portion such that a segment positioned therein rests with its first electrode on the first contact surface and with its second electrode on the second contact surface. It has been found that such an arrangement of the contact surfaces allows efficient testing of the respective segment.

Preferably, the segment is a monocell with the four-layer structure described above. The disclosure of this application also explicitly includes the proposed device together with one segment or a plurality of segments, for example in the form of the monocell, which is or are mounted in the receiving portions.

According to another preferred embodiment, the receiving portions each have openings to which a negative pressure can be applied to hold the segments. The segments, in particular the conductor lugs, can be held particularly gently by means of negative pressure since there is no need for grippers or clamps that can damage the conductor lugs. The openings can be arranged on the rest surface and/or on the contact surfaces. Furthermore, the openings can be formed, for example, by retaining holes or by the pores of an air-permeable material.

In principle, however, mechanical holders, such as grippers or levers, are also conceivable for bringing the segments into contact with the contact surfaces.

The object mentioned above is also achieved by a method for testing segments that are intended to form a cell stack for the energy cell producing industry, wherein the segments are tested by the testing device according to one of the preceding claims, wherein the segments to be tested are each positioned in one of the receiving portions. Preferably, the segments are tested while the conveying apparatus is moving relative to the stationary part. The detection of a defective segment can then lead to the segment being ejected from the production process; this can be done by means of the testing device itself or by means of a separate apparatus, for example an ejection drum. With regard to the technical effects and advantages associated with the proposed method, reference is made to the previous explanations in connection with the testing device.

The invention is explained below using preferred embodiments with reference to accompanying figures. In the figures:

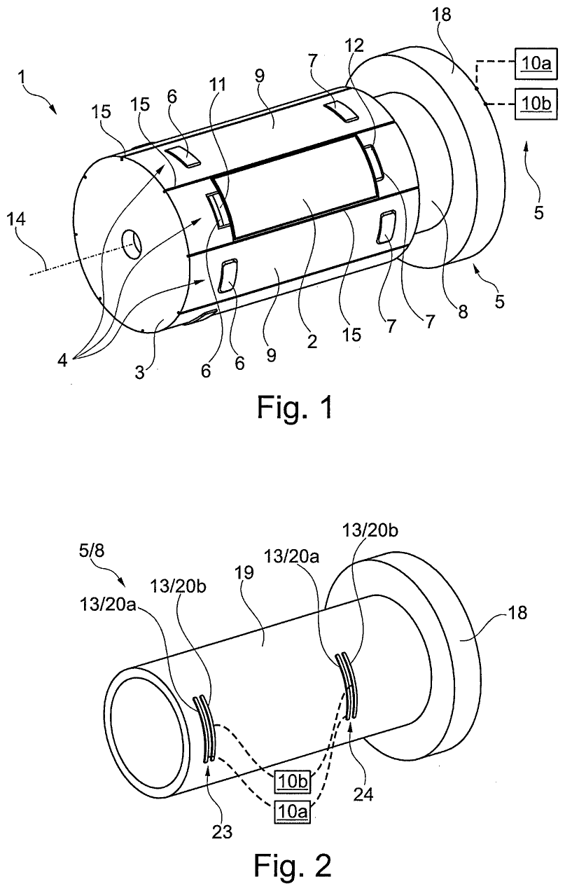

FIG. 1 is a perspective view of the testing device;

FIG. 2 shows an axle element and two measuring apparatuses;

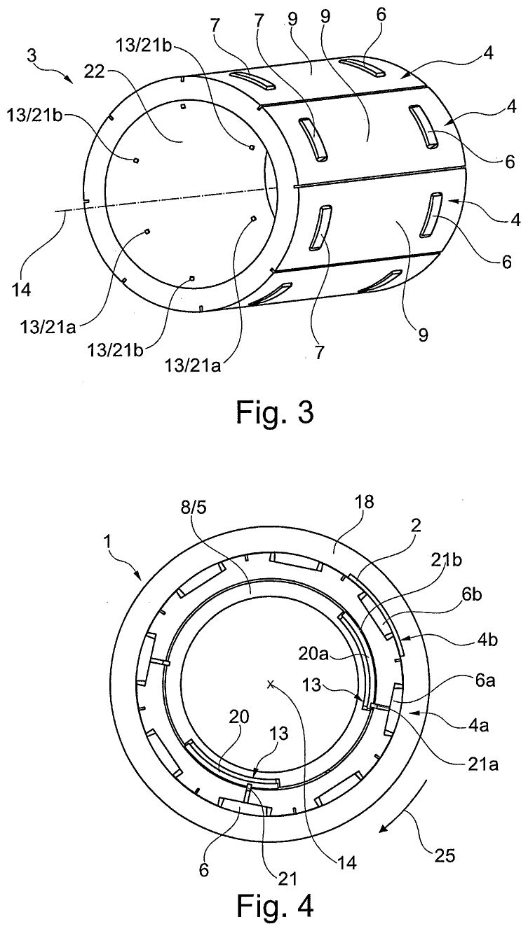

FIG. 3 shows a conveying apparatus; and

FIG. 4 is a sectional view of a testing apparatus.

FIG. 1 shows a perspective view of a testing device 1 for testing segments 2, wherein the segments 2 are suitable for forming cell stacks for the energy cell producing industry. By stacking such segments 2 on top of each other to form a cell stack (not shown), battery cells can be formed. The segment 2 shown in FIG. 1 has a four-layer structure with the following layer sequence: separator-electrode (e.g. anode)-separator-electrode (e.g. cathode). Thus, segment 2 is what is known as a monocell.

The testing apparatus 1 of FIG. 1 can be arranged, for example, between a device (not shown) for producing the segments 2 and a cell stacking device (also not shown) for forming cell stacks.

The testing device 1 comprises a conveying apparatus 3 in the form of a drum, which is rotatably mounted on an axle element 8 so as to rotate about a rotation axis 14 during operation. Furthermore, the testing device 1 comprises a plurality of measuring apparatuses 10a, 10b, two of which are shown schematically. The measuring apparatuses 10a, 10b can be designed, for example, to measure an ohmic resistance. Of course, measuring apparatuses 10a, 10b with which other parameters can be measured are also conceivable in principle. The axle element 8 and the measuring apparatuses 10a, 10b are part of a stationary part 5 of the testing device 1 which thus does not corotate with the conveying apparatus 8.

Furthermore, FIG. 1 shows that, on the radially outer lateral surface of the drum-shaped conveying apparatus 3, a plurality of receiving portions 4 is arranged, which are designed for receiving one segment 2 in each case. The individual receiving portions 4 are structurally separated from one another by one groove 15 in each case, the grooves being oriented parallel to a rotation axis 14 of the conveying apparatus 3. By rotation of the conveying apparatus 3 around the axle element 8, the segments 2 can be moved 15 on a circular path. The conveying apparatus 2 can be rotated continuously or discontinuously by means of a drive unit (not shown).

In FIG. 1, only one of the receiving portions 4 is occupied by a segment 2. In principle, however, a plurality of the receiving portions 4 can be occupied by a segment 2 in parallel during operation. Each receiving portion 4 comprises a first contact surface 6 and a second contact surface 7 with which the electrodes of the segment 2 mounted in the receiving portion 4 can be contacted. The contact surfaces 6, 7 are arranged such that they contact what are known as conductor lugs 16, 17, each of which is part of one of the electrodes of the segment 2. In the receiving portion 4, the segment 2 is in electrically conductive contact with the first contact surface 6 by means of a first conductor lug 11, which here is part of an anode. Furthermore, a second conductor lug 12, which here is part of a cathode, is in electrically conductive contact with the second contact surface 7.

In the receiving portions 4, the segments 2 rest on rest surfaces 9, which in this exemplary embodiment are electrically non-conductive. In order to ensure that the respective segment 2 can be held reliably and gently in the receiving portion 4, openings (not shown) are provided on the rest surface 9 and on the contact surfaces 6 and 7, to which openings a negative pressure can be applied. In this way, the segments 2 can be gently held in the receiving portion 4 by the pressure difference that arises in comparison with the environment.

The establishment of an electrically conductive connection between the measuring apparatuses 10a, 10b and the contact surfaces 6, 7 is carried out in each case by means of a sliding contact apparatus 13 comprising in each case a contact skid 20a, 20b and a contact brush 21a, 21b, which is explained in more detail with reference to FIGS. 2, 3 and 4.

FIG. 2 shows an axle element 8 comprising a cylindrical lateral surface 19 and a flange 18 at one end, said flange forming a stop for the drum-shaped conveying apparatus 3 (cf. FIG. 1) rotatably mounted on the axle element 8.

Furthermore, it can be seen in FIG. 2 that the contact skids 20a, 20b, as part of the sliding contact apparatuses 13, are arranged radially outside on a cylindrical lateral surface 19 of the axle element 8 and said contact skids extend over a part of the circumference. Furthermore, it can be seen that the contact skids 20a, 20b are arranged in pairs. Although the individual contact skids 20a, 20b of a contact skid pair 23, 24 have the same length and arrangement in the circumferential direction with respect to the rotation axis 14, they are arranged one behind the other in the direction of the rotation axis 14. A first contact skid pair 23 is associated with the first contact surfaces 6 and a second contact skid pair 24 is associated with the second contact surfaces 7. The two contact skids 20a of the first and second contact skid pairs 23 and 24 are electrically connected to a first measuring apparatus 10a, while the two contact skids 20b of the first and second contact skid pairs 23 and 24 are electrically connected to a second measuring apparatus 10b. The arrangement of the contact skids 20a and 20b in pairs allows the contact surfaces 6, 7 of adjacent receiving portions 4 to be connected to the measuring apparatuses 10a and 10b with temporal overlap, i.e. connected in parallel.

FIG. 3 shows the contact brushes 21a, 21b which are arranged on the radially inner surface 22 of the drum-shaped conveying apparatus 3 and which, according to the rotational position of the conveying apparatus 3 relative to the axle element 8, can be contacted with the contact skids 20a, 20b shown in FIG. 2. The contact brushes 21a and 21b of adjacent receiving portions 4 have an offset in the direction of the rotation axis 14, so that the contact brush 21a can be contacted with the contact skid 20a and the contact brush 21b can be contacted with the contact skid 20b. This applies both to the sliding contact apparatuses 13 which are associated with the first contact surfaces 6 and to those which are associated with the second contact surfaces 7. In this way, the contact skids 20a, 20b of a contact skid pair 23, 24 (cf. FIG. 2) can be contacted alternately by the corresponding contact brushes 21a and 21b of adjacent receiving portions 4.

The duration of the electrically conductive connection of the contact surfaces 6, 7 of a receiving segment 4 to the stationary part 5 can be determined according to the length of the contact skids 20a, 20b along the circumference of the axle element 8 and according to the rotational speed of the conveying apparatus 3 relative to the axle element 8. In this exemplary embodiment, each of the contact surfaces 6, 7 is associated its own contact brush 21a, 21b.

FIG. 4 shows the testing apparatus 1 in a sectional view with a section orthogonal to the rotation axis 14 in the plane of the first contact surfaces 6. It can be seen that a segment 2 is mounted in a receiving portion 4b, which is adjacent to the receiving portion 4a. Furthermore, a contact surface 6b of the receiving portion 4b is shown, with which contact surface the conductor lug 11 of the segment 2 is in electrically conductive contact. By means of a contact brush 21b, the contact surface 6b in contact with a contact skid 20b (cf. FIG. 2) which is not visible in this sectional plane and which is arranged behind the contact skid 20a shown here. In this view, the contact skid 20b is concealed by the contact skid 20a. The receiving portion 4a which is adjacent to the receiving portion 4b comprises, in contrast, a contact surface 6a which, by means of the contact brush 21a, is in electrically conductive contact with the contact skid 20a visible in this sectional plane. The contact brushes 21a and 21b of adjacent receiving portions 4a and 4b thus simultaneously contact different contact skids 20a and 20b of one and the same contact skid pair 23. If the drum-like conveying apparatus 3 is rotated further in direction of rotation 25 relative to the axle element 8, the contact between the contact brush 21a and the contact skid 20a is ended, while the contact between the contact brush 21b and the contact skid 20b persists for a defined further rotational movement. The same applies, mutatis mutandis, to the contact skids 20a and 20b of the contact skid pair 24.

The measuring apparatuses 10a and 10b (cf. FIGS. 1 and 2) can thus be connected in an electrically conductive manner to the contact surfaces 6, 7 of adjacent receiving portions 4a, 4b separately, but with temporal overlap, via the sliding contact apparatuses 13. Each of the measuring apparatuses 10a, 10b is thus always only connected to the contact surfaces 6, 7 of one receiving portion 4a or 4b.

In principle, the assignment of the contact brushes 21a, 21b and contact skids 20a, 20b to the conveying apparatus 3 and to the axle element 8 is also interchangeable, so that the contact brushes 21 can also be associated to the axle element 8 and the contact skids 20 can also be associated to the conveying apparatus 3.

1. A testing device for testing segments that are suitable for forming a cell stack for the energy cell producing industry, wherein:
a conveying apparatus with a plurality of receiving portions is provided for receiving and transporting a segment in each case, wherein
the receiving portions can be moved relative to a stationary part of the testing device by a movement of the conveying apparatus, wherein
the receiving portions each comprise at least two contact surfaces for electrical and/or signalling contact of a segment received in the corresponding receiving portion.

2. The testing device according to claim 1, wherein the conveying apparatus is formed by a drum which is mounted for rotation around an axle element and on a radially outer lateral surface of which the receiving portions are arranged.

3. The testing device according to claim 1, wherein the receiving portions each comprise a rest surface for supporting a segment, the rest surface being electrically insulated from the contact surfaces.

4. The testing device according to claim 1, wherein the contact surfaces of the receiving portions can be connected to at least one measuring apparatus with respect to signalling and/or electrically.

5. The testing device according to claim 4, wherein the signalling and/or electrical connection of one or more contact surfaces of a specific receiving portion to the at least one measuring apparatus can be established and/or interrupted according to the position of the conveying apparatus relative to the stationary part.

6. The testing device according to claim 4, wherein the at least one measuring apparatus is part of the stationary part.

7. The testing device according to claim 6, wherein the signalling and/or electrical connection of one or more of the contact surfaces of a respective one of the receiving portions to the at least one measuring apparatus can be established by means of at least one sliding contact apparatus.

8. The testing device according to claim 5, wherein
a plurality of measuring apparatuses is provided, wherein
the signalling and/or electrical connection of the contact surfaces of two or more receiving portions, each to a different measuring apparatus, can be established with temporal overlap.

9. The testing device according to claim 1, wherein the receiving portions each comprise a first and a second contact surface which are arranged in the respective receiving portion such that they are electrically insulated from one another.

10. The testing device according to claim 9, wherein the first and second contact surfaces are arranged in the respective receiving portion such that a segment positioned therein has its first electrode applied to the first contact surface and its second electrode applied to the second contact surface.

11. The testing device according to claim 1, wherein the receiving portions each have openings to which a negative pressure can be applied to hold the segments.

12. A method for testing segments that are intended to form a cell stack for the energy cell producing industry, wherein the segments are tested by the testing device of claim 1, and wherein the segments to be tested are each positioned in one of the receiving portions.
